(19) United States
(12) Patent Application Publication
(10) Pub. No.: US 2026/0004140 A1
(43) Pub. Date: Jan. 1, 2026

(54) MACHINE LEARNING CLUSTERING OF EMBEDDINGS CREATED FOR CATEGORICAL DATA USING LARGE LANGUAGE MODELS

(71) Applicant: ACTIMIZE LTD, Ra'anana (IL)

(72) Inventors: Sumit KUMAR, Pune (IN); Prasad MHATRE, Pune (IN); Danny BUTVINIK, Haifa (IL)

(21) Appl. No.: 18/754,526

(22) Filed: Jun. 26, 2024

(51) Int. Cl. G06N 3/091

(52) U.S. Cl. CPC G06N 3/091

(57) ABSTRACT

An autonomous machine learning (ML) system and methods are provided that are configured to intelligently cluster categorical data based on embeddings created by prompting a large language model (LLM). The system includes a processor and a computer readable medium operably coupled thereto, the computer readable medium comprising a plurality of instructions stored in association therewith that are accessible to, and executable by, the processor, to perform embedding generation operations which include accessing a data set for categorical data, determining a row of the data set, generating a data container corresponding to the row and an instruction to the LLM that requests an embedding for the row, prompting the LLM to create the embedding using the data container, reducing a dimensionality of the embedding, and outputting the reduced dimensionality embedding to an ML training application executing for training an ML clustering model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for anti-money laundering (AML) and fraud detection with financial institutions, and more specifically to a system and method for creating embeddings for ML clustering using generative Als including large language models (LLMs).

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Financial crimes, such as money laundering, fraud, and other illicit activities, threaten the financial industry by undermining trust, integrity, and stability that users have in their financial institutions. These crimes may cause significant damages in both financial and reputational terms. Financial institutions have responded by implementing various risk management and investigation techniques to mitigate these risks. These require specific systems, departments, and trained agents and investigators to resolve and prevent such crimes, recover lost or stolen funds, and/or identify bad actors and fraudulent entities. However, fraud and money laundering schemes and techniques are constantly changing, and new strategies, vulnerabilities, or other techniques by which fraud or money laundering can be conducted and/or financial institutions exploited are constantly being identified by bad actors. As such, intelligent systems for automating fraud detection and prevention require more advanced and evolving techniques and solutions. This includes ML clustering algorithms and techniques to identify bad actors and fraudulent activities by drawing correlations between different user's data. However, ML algorithms may perform poorly at understanding categorical data and properly clustering such data, thereby missing fraudulent activity and/or mischaracterizing valid or nonfraudulent activity. This is problematic at scale with complex systems, which allows vulnerabilities to be exploited by bad actors and malicious entities, or alternatively can lead to “false positives” of misidentifying legitimate activity.

LLMs have caused a profound technological shift with artificial intelligence (AI) systems, allowing for new and unique solutions through automated conversational machines and models. These models, trained on vast corpora of global knowledge, exhibit remarkable prowess in understanding intricate semantic relationships within textual data. With an adept understanding of user queries, LLMs may offer resolutions to different problems using natural language and intelligent automated conversations. However, with the abundance of unlabeled data in various industries, conventionally the capabilities of LLMs are not sufficiently adaptable to tackle the complexity of predictive modeling with this unlabeled and/or non-conversational data. While LLMs excel with text-based data, LLMs do not generally handle tabular data. For example, LLMs require prompts to generate predictions for textual data and/or corpora of documents from which to learn and respond to the prompts. Further, approaches to handling tabular data require safeguards for data privacy. This may include eliminating sharing of sensitive information externally while still enabling pattern learning from both internal and external data sources by LLMs.

Additionally, while deep learning excels at learning latent relationships from data with minimal feature engineering, deep learning may overfit data when applied to smaller datasets. Further, deep learning may rely solely on traditional ML techniques, missing out on the vast knowledge base of LLMs. Thus, deep learning and ML models may not be readily optimized and improved through the use of LLMs to identify relevant data from large text and other data sources, as well as relationships between such data. As such, it is desirable to integrate LLMs into training enhanced deep learning and other ML models while utilizing internal data effectively and safely (e.g., minimizing external data exposure for data privacy). Therefore, there is a need for improvements to ML clustering and other models' performances when understanding and utilizing categorical data.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified diagram of a pipeline for generating embeddings of categorical data using an LLM for ML clustering according to some embodiments.

FIG. 3 is a simplified diagram for prompting an LLM with instructions to create embeddings from categorical data for ML clustering according to some embodiments.

FIG. 4 is a simplified diagram of an exemplary table of categorical data having rows for different records including variables for categorical observations according to some embodiments.

FIG. 5 is a simplified diagram of an exemplary prompt to an LLM when instructing the LLM to generate embeddings from categorical data according to some embodiments.

FIG. 6 is a simplified diagram of an exemplary flowchart for generating embeddings of categorical data for ML clustering according to some embodiments.

FIG. 7 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

A service provider, such as a customer relationship management (CRM) and/or fraud detection system and provider, may implement an intelligent ML framework that integrates LLMs into training process to harness their capabilities when processing tabular data that may include categorical variables having corresponding categorical observations. In data tables, different data variables may correspond to numerical values and/or categorical data having text values or observations. Since LLMs generally accept text prompts as input, tabular data having categorical columns may be required to be transformed into narrative prompts for processing by the LLM. These narratives may then be converted into embeddings representing the features for the ML model that are learned by the LLM during training. For example, features may correspond to individual inputs that may be used to train an ML model, such as an ML clustering model that implements a cluster-based technique or algorithm, to make predictions, observations, or determinations, or a combination thereof. This may include assigning data to clusters and clustering similar data so that observations and deductions may be made for ML predictive outputs. To further enhance efficiency, principle component analysis (PCA) can be applied to reduce a dimensionality of the output embeddings from a higher feature or vector space (e.g., of n-dimensions) to a lower space (e.g., of n minus 1, 2, 3 . . . m, where m is greater than 0 and m does not equal n so that there would be 0 dimensions). Dimensionality reduction may be performed before employing unsupervised ML techniques to the embeddings to cluster the embeddings. Embeddings may correspond to vectors representing the ML features for clustering and ML model training, which may be used to assign or match new or live data to particular clusters and make associations, predictions, or determinations based on cluster behaviors and/or behaviors associated with the new or live data.

For example, service providers may implement an intelligent embedding generation and clustering system that utilizes generative AI services and systems, such as conversational AIs, LLMs, generative pretrained transformers (GPTs), and the like. As such, an ML system configured to intelligently cluster categorical data based on embeddings may utilize conversational AIs and chatbots, reinforcement ML, recommendation systems, decision-making algorithms, and other related components. These components create intelligent and autonomous or semi-autonomous embedding generation for clustering of categorical data of categorical observations (e.g., in place of numerical or quantifiable values, where each variable or feature in a table may instead have a categorical observation, such as red, green, blue for colors, in place of data values). ML and neural network (NN) algorithms and techniques may be utilized for clustering the resulting embeddings, allowing for training for ML clustering models for inferences, predictions, and decisions regarding similar, matching, or correlated data. This allows for ML clustering algorithms to be better trained on categorical data having categorical observations for values of variables or features of the ML models, thereby enhancing accuracy and providing more robust and comprehensive AI tools.

ML models may be built on different tenants of a fraud/money laundering, reporting, and/or ML modeling system, such as different financial institutions, using historical or past activities, transactions, and/or other model training data. Fraud/money laundering investigation is a process that detects and prevents (i.e., minimizes frequency and/or amount, or completely avoids) fraudsters from obtaining money or property illegally, through fraud, or other misappropriation. This may include detecting, alerting, and/or blocking fraudsters from obtaining money or property fraudulently, as well as assisting with investigations after fraud has been conducted to identify and prosecute those fraudsters, claw back ill-gotten gains, and/or protect a person or financial service provider from further fraud. Fraudulent activities may include money laundering, cyberattacks, fraudulent banking claims, forged bank checks, identity theft, and other illegal and/or malicious practices and conduct. As such, ML models may assist with detecting when fraudulent activities occur or are suspected.

A service provider may have or have access to an abundant amount of unlabeled tabular data of users, entities, and/or accounts. With feature engineering, the service provider may establish a set of features to use for the predictive model. Features may be categorical or numerical. An algorithm may be used to create a peer group and based on the peer group identify a party's (e.g., user, entity, account, etc.) behavior. If the behavior of the party is different from their peers, then the party may be flagged and/or an issue raised for further analysis and potential alerting. Further, the service provider may have a context to the change in behavior based on the historical behavior for the raised issue. These issues may be combined and, if meeting or exceeding a pre-defined threshold, an alert may be automatically generated by the ML model and/or engine after clustering.

For model training, once the data is finalized and preprocessed, the service provider may proceed to narrative generation. An LLM may be trained and configured to learn the embedding that has a sufficient degree of dimensionality for an understanding of one or more relationships among the data. This may include the use of GPT-4 or other GPTs, LLMs, or the like to provide conversational and/or generative AI services during embedding generation. For example, an LLM may provide natural language processing to analyze and understand large amounts of textual data related to financial transactions, customer information, regulatory requirements, and other relevant sources for categorical data, and translate or transform that data into embeddings that may correspond to mathematical or numerical representations of the underlying categorical data, such as a vector of n-dimensionality based on the features of interest or at stake.

As such, the approach may include using the LLM model embeddings to train the ML clustering model so that the ML clustering algorithms and techniques may leverage the use of LLMs in understanding the meaning of categorical values. For example, traditional one-hot encoding may simply encode categorical values to some random state, which does not provide true features of that dataset. Since foundational LLMs may accept only prompt/text as an input, tabular data input may therefore be required to be first converted to narratives. A narrative format and/or template may be determined so that the narrative generator may convert each row of data into a form of a narrative. Since converting directly from rows of data to a narrative may be ambiguous, an additional conversion step may be implemented to take a row and convert into JavaScript Object Notation (JSON) format and then, from the JSON formatted data and containers, convert the data to narratives.

When converting data, one narrative may be taken at a time and, using an OpenAI application programming interface (API) and API calls to the OpenAI API, or API of another LLM, the narratives may be converted into embeddings by the LLM. A vector database may be chosen and used for storing the generated embeddings. As such, these stored embeddings may represent the text data in numerical format, which may then be used for ML model training. ML algorithms and other ML software training techniques and operations may require these numerical representations for training. As such, the embeddings having vectorized categorical data, may be utilized for model training, which allows paragraphs of text or any other object to be reduced to a vector. Further, numerical data may also be used with the categorical data when generating vectors for additional insights from ML clustering based on the numerical features.

PCA or another dimensionality reduction process may be applied that reduces the dimensionality of large data sets by transforming a large set of variables into a smaller one that still contains most, if not all, of the information in the large set. With a larger number of dimensions, e.g., more than eight (8), an ML model may overfit data. Overfitting may correspond to model error and behavior where the model functions and outputs are too closely aligned with the input data or training data, and therefore are only useful with the training data. As such, PCA may be used, which may apply feature extraction to map a higher dimensional feature space to a lower-dimensional feature space. While reducing the number of dimensions, PCA may further ensure that a maximum amount of information from the original dataset is retained in the dataset with the reduced number of dimensions and the co-relationships between dimensions in the newly obtained embeddings is at a minimum (e.g., a minimum number of dimensions to retain the information from the original dataset).

Thereafter, with the reduced dimension embeddings, an ML clustering algorithm and/or technique may be applied to train an ML clustering model. In some embodiments, k-mean clustering may be used for ML clustering and model training. K-means clustering may correspond to an unsupervised ML algorithm used for partitioning data into clusters. This may group similar data points together while keeping dissimilar points apart. During model training, initialization may be performed to choose the number of clusters (k) and randomly initialize k cluster centroids. During cluster assignment, each data point may be assigned to the nearest cluster centroid based on a distance metric, such as Euclidean distance. The cluster centroids may be updated by computing the mean of all data points assigned to each cluster. These steps may be repeated until convergence criteria are met, such as when the centroids no longer change location significantly during a further iteration or when a maximum number of iterations is reached. As such, the algorithm converges to a final set of cluster centroids and each data point may be assigned to one of the k clusters. Finally, a model evaluation may be performed to evaluate the model's performance against a chosen parameter or metric. For each metric, a visualization may be used for checking the performance of the ML model using LLM-based feature embeddings.

The embodiments described herein provide methods, computer program products, and computer database systems for an ML system that programmatically processes categorical data to generate corresponding embeddings using an LLM. Thereafter, these embeddings may be used to train an ML model for clustering of data records and tables including categorical data, thereby providing more accurate and comprehensive model training and inferencing. A financial institution, or other service provider system having one or more financial institutions as customers or other tenants, may therefore include and/or utilize a fraud and/or money laundering reporting system that may implement an ML system as described herein. The framework of intelligent fraud detection or other ML task may therefore be improved through the embeddings generation and clustering operations provided herein.

According to some embodiments, in an ML system accessible by a plurality of separate and distinct organizations, ML algorithms, features, and models are provided for intelligently clustering categorical data based on embeddings created by an LLM, thereby providing more accurate, efficient, and precise ML model training with more comprehensive understanding of categorical data.

### Example System and Computing Environment

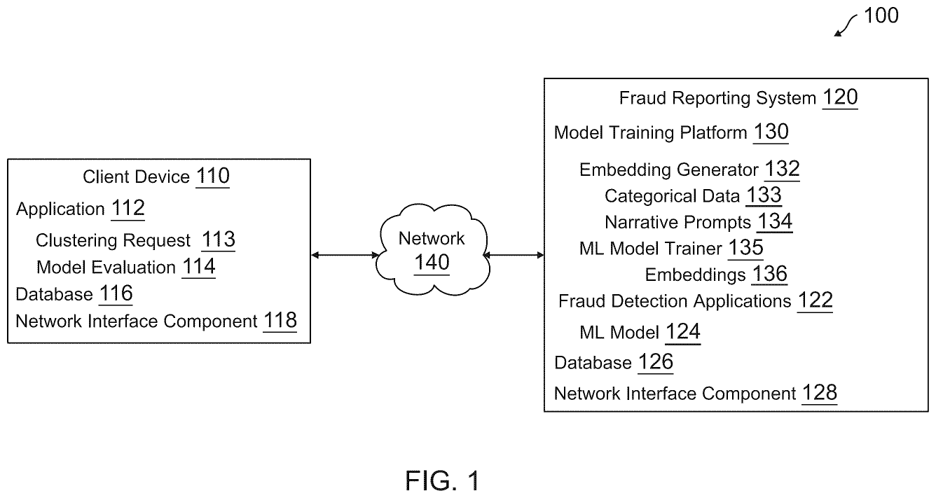

The system and methods of the present disclosure can include, incorporate, or operate in conjunction with, or in the environment of, an ML engine, model, and intelligent system, which may include an ML or other AI computing architecture that provides embedding generation for ML clustering of categorical data. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, NNs, and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a fraud reporting system 120 that interact over a network 140 to provide intelligent fraud/AML detection and/or investigation, or other ML task processing, through ML clustering models that may be trained using embeddings of categorical data generated by an LLM, as discussed herein. In other embodiments, environment 100 may not have all of the components listed and/or may have other elements instead of, or in addition to, those listed above. In some embodiments, environment 100 is an environment in which a model training platform 130 may prompt LLMs and other generative AIs to orchestrate embedding generation of categorical data. As illustrated in FIG. 1, fraud reporting system 120 might interact via a network 140 with client device 110 to train, configure, and provide evaluations of ML clustering models.

For example, in fraud reporting system 120, fraud detection applications 122 may provide and/or process transaction data, user data, and/or historical data for fraud/money laundering and risk analysis using one or more ML or NN models, such as LLMS, GPTS, and other generative and/or conversational AI. These may include ML fraud/money laundering engines that may use ML clustering models trained for fraud/money laundering; however, other types of ML tasks and/or ML models may be used. Fraud flags and/or reports may be generated from detected or suspected fraud, which may be based on comparing incoming data to clusters of user, transaction, or other data as determined by ML clustering techniques and algorithms. Those clusters may be generated by model training platform 130 using an embedding generator 132 that prompts an LLM to generate embeddings from categorical data 133. In this regard, narrative prompts 134 may be generated using prompt templates and/or other prompt data for prompting LLMs to generate embeddings from categorical data. Narrative prompts 134 may correspond to data structures or data containers, such as JavaScript Object Notation (JSON) data containers, which may include one or more rows of data (e.g., data records) from unlabeled tabular data or other data tables of categorical data, which may include categorical observations for different variables and/or ML features. In this regard, narrative prompts 134 may also include instructions, such as in text form, which instructs an LLM to generate an embedding from the data rows in each container.

The ML models for detecting fraud by fraud detection applications 122 may correspond to different types of ML models including clustering models, decision trees, NNs, and the like. In this regard, clustering models may utilize embeddings generated from categorical data 133 by embedding generator 132 through prompting an LLM using narrative prompts 134. These trained models may include offline and/or online ML models, where offline ML models may be trained and deployed based on a training data set and online ML models may provide continuous learning and adaptation to new and changing datasets, such as emerging trends using live or streaming data. As such, fraud reporting system 120 may be utilized to provide ML operations to tenants, customers, and other users or entities via fraud detection applications 122, which may include detecting and processing fraud data and potentially fraudulent activities. ML models may be trained by an ML model trainer 135 using embeddings 136 from embedding generator 132 and corresponding to vectors or other mathematical representations (e.g., of n-dimensionality depending on the features to be clustered and/or after dimensionality reduction to reduce those features to a smaller feature and dimensional space).

To investigate real or potential fraud, an ML model 124 may be trained by ML model trainer 135 using embeddings 136. Fraud detection applications 122 may therefore provide fraud/money laundering services through ML model 124 after training based on embeddings 136 using a clustering algorithm or technique, such as k-means clustering. ML model 124 may include and/or be utilized in conjunction with computing services provided by and/or to customers, tenants, and other users or entities accessing and utilizing fraud reporting system 120 through fraud detection applications 122. ML fraud/money laundering engines of fraud detection applications 122 may be executed by fraud reporting system 120 and/or provided to be utilized with other ML systems and models, such as those managed by separate computing systems, servers, and/or devices (e.g., tenant-specific or tenant-controlled servers and/or server systems that may be separate from Model training platform 130 discussed herein). Client device 110 may include an application 112 that provides a clustering request 113 that requests categorical data 133 be clustered and utilized for training of ML model 124. As such, clustering request 113 may initiate a process to generate embeddings 136 and then train ML model 124 by ML model trainer 135 using embeddings 136. Thereafter, ML model 124 may be analyzed and evaluated for model performance, and a model evaluation 114 may be provided to client device 110 so that performance may be determined, and retraining, deployment, or other actions taken.

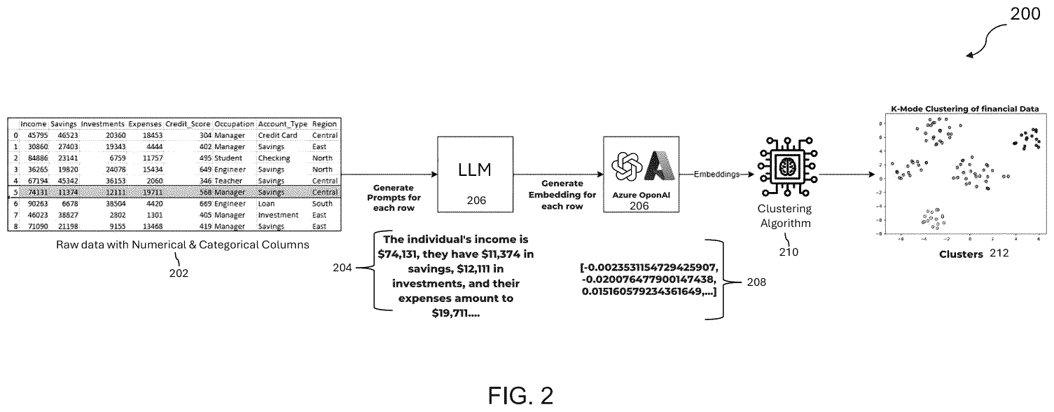

In this regard, narrative prompts 134 may utilize different generative AI prompts and prompting strategies to call generative AI services with one or more requests, statements, questions, queries, or the like that are designed to elicit a response that allows for generation of embeddings 136. As such, narrative prompts 134 may include LLMs prompts generated from prompt templates based on categorical data 133, which may include data rows for different data records from unlabeled tabular data (e.g., unlabeled tables having rows for different records and columns for different variables that may correspond to ML features, such as by each variable correspond to a feature or multiple variables corresponding to or being processed to determine a feature). The variable in the unlabeled tabular data of categorical data 133 may correspond to categorical observations instead of data values, and as such, embedding generation requires encoding or transforming to be represented by values for ML model training. Embedding generator 132 may request embeddings generated by an LLM from the categorical observations by narrative prompts 134. Responses from generative AI services may include embeddings 136 that may be used for model training. Narrative prompts 134 may be designed to elicit responses that may be used to generate embeddings 136 and prevent or minimize generative AI “hallucinations” (e.g., false or AI created data from previous samples, training data, or learning that does not match the categorical data). As such, model training platform 130 may leverage generative AIs, LLMs, GPTs including GPT-4, and the like for generative AI services to create embeddings 136. Model training platform 130 may not rigidly specify a certain generative AI model and generative AI models, LLMs, GPTs, and the like may be added or removed modularly and as needed. Although generative AI services are discussed as internal and residing with fraud reporting system 120, in other embodiments, external or third-party AI services and platforms may be similarly called. The operations, components, and models of model training platform 130, such as those of embedding generator 132 and ML model trainer 135, are discussed in further detail below with regard to FIGS. 2-6 below.

For ML models (e.g., clustering algorithms and operations, decision trees and corresponding branches, NNs, etc.), the models may be trained using training data, which may correspond to stored, preprocessed, and/or feature transformed data associated with embeddings 136. With continuous and/or reinforcement training, live streaming data from one or more production, live, and/or real-time computing environments may be used. Model training and configuring may include performing feature engineering and/or selection of features used by ML models. Features may correspond to discreet, measurable, and/or identifiable properties or characteristics; however, as discussed herein, such features may include categorical data 133 having categorical observations that are converted to embeddings 136 for ML clustering. ML and NN models used by fraud reporting system 120 may be trained using one or more ML algorithms, operations, or the like for modeling (e.g., including clustering data points and/or embeddings, configuring decision trees or neural networks, and/or adjusting clusters, weights, activation functions, input/hidden/output layers, and the like). Thus, one or more ML models, NNs, or other AI-based models and/or engines may be trained for fraud/money laundering detection, investigation, or another ancillary ML task. The training data may be labeled or unlabeled for different supervised or unsupervised ML and NN training algorithms, techniques, and/or systems. Fraud reporting system 120 may further use features from such data for training, where the system may perform feature engineering and/or selection of features used for training and decision-making by one or more ML, NN, or other AI algorithms, operations, or the like (e.g., including configuring clusters, cluster representatives and/or membership/attribution, decision trees, weights, activation functions, input/hidden/output layers, and the like). ML model 124 and/or other ML models be trained using a function and/or algorithm used by ML model trainer 135, as well as other ML systems, trainers, and operations for model and/or engine training and development. The training may include establishment and/or adjustment of clusters, cluster similarity distances, weights, activation functions, node values, and the like. After initial training of ML models using supervised or unsupervised ML algorithms (or combinations thereof), ML models may be evaluated and/or released in a production computing environment. ML models may be deployed to take and process input data for model features and predict labels or other classifiers from the input data.

One or more client devices and/or servers (e.g., client device 110 using application 112) may execute a web-based client that accesses a web-based application for fraud reporting system 120, or may use a rich client, such as a dedicated resident application, to access fraud reporting system 120, which may be provided by fraud detection applications 122 to such client devices and/or servers. Client device 110 and/or other devices or servers may utilize one or more application programming interfaces (APIs) to access and interface with fraud detection applications 122 and/or ML fraud/money laundering engines of fraud reporting system 120 to access, review, and evaluate transactions, fraud indications, and/or other ML tasks using the operations discussed herein. Interfacing with fraud reporting system 120 may be provided through fraud detection applications 122 and/or model training platform 130, and may be based on data stored by databases 126 of fraud reporting system 120 and/or a database 116 of client device 110.

Client device 110 and/or other devices and servers on network 140 might communicate with fraud reporting system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and fraud reporting system 120 may occur over network 140 using a network interface component 118 of client device 110 and a network interface component 128 of fraud reporting system 120. In an example where HTTP/HTTPS is used, client device 110 might include an HTTP/HTTPS client for application 112, commonly referred to as a “browser,” for sending and receiving HTTP//HTTPS messages to and from an HTTP//HTTPS server, such as fraud reporting system 120 via the network interface component.

Similarly, fraud reporting system 120 may host an online platform accessible over network 140 that communicates information to and receives information from client device 110. Such an HTTP/HTTPS server might be implemented as the sole network interface between client device 110 and fraud reporting system 120, but other techniques might be used as well or instead. In some implementations, the interface between client device 110 and fraud reporting system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with fraud reporting system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or fraud reporting system 120 may be included by the same system, server, and/or device and therefore communicate directly or over an internal network.

According to one embodiment, fraud reporting system 120 is configured to provide webpages, forms, applications, data, and media content to one or more client devices and/or to receive data from client device 110 and/or other devices, servers, and online resources. In some embodiments, fraud reporting system 120 may be provided or implemented in a cloud environment, which may be accessible through one or more APIs with or without a corresponding graphical user interface (GUI) output. Fraud reporting system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for fraud detection applications 122 and/or model training platform 130 of fraud reporting system 120. In one embodiment, client device 110 includes application servers configured to implement and execute software applications as well as provide related data, code, forms, webpages, platform components or restrictions, and other information, and to store to, and retrieve from, a database system related data, objects, and web page content. For example, fraud reporting system 120 may implement various functions of processing logic and processing components, and the processing space for executing system processes, such as running applications for fraud/AML investigations and/or other risk analysis and fraud/money laundering capabilities. Client device 110 and fraud reporting system 120 may be accessible over network 140. Thus, fraud reporting system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients. Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to fraud reporting system 120 that provides one or more APIs for interaction with client device 110.

Thus, client device 110 and/or fraud reporting system 120 and all of their components might be operator configurable using application(s) including computer code to run using a central processing unit, which may include an Intel Pentium® processor or the like, and/or multiple processor units. A server for client device 110 and/or fraud reporting system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and fraud reporting system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, as well as other media including magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Embedding Generation and Clustering System

FIG. 2 is a simplified diagram 200 of a pipeline for generating embeddings of categorical data using an LLM for ML clustering according to some embodiments. Diagram 200 of FIG. 2 includes a data pipeline and/or series of interactions to process raw data 202 from a data table for ML clustering using an ML clustering algorithm and/or technique. In this regard, the operations to process raw data 202 described with reference to and shown in diagram 200 may be executed by the operations and components of fraud reporting system 120 including model training platform 130 discussed in reference to environment 100 of FIG. 1. In this regard, diagram 200 displays the data processing pipeline for purposes of generating and clustering embeddings from categorical data using LLMs.

A service provider, such as a fraud or money laundering detection system and/or server(s) (e.g., fraud reporting system 120), may implement and deploy an embedding generation and processing pipeline shown in diagram 200. In diagram 200, raw data 200 represents numerical and categorical data, such as unlabeled tabular data or another data table representing data records each having a plurality of variables corresponding to the features to be processed by an ML model and used for embedding generation and/or ML model clustering. For example, individual variables in raw data 202 may correspond to the columns, each having a corresponding identifier, value, observation, or the like for numerical data (e.g., income, savings, investments, expenses, credit scores, etc.) or categorical data (e.g., occupation, account type, region, etc.). Raw data 202 may therefore be taken as input and prompts 204 may be generated for each row by creating narratives from the categorical data, as well as any numerical data of relevance, significance, or interest for the ML clustering algorithm and/or model. In this regard, an LLM 206 is called using a data structure or container including one or more rows of data with an instruction to create a narrative, such as by inserting categorical data into a prompt template and/or creating a prompt, description, or other narrative structure that describes the categorical, as well as numerical when used, data.

As such, prompts 204 may be generated for each row of data using an LLM, where prompts 204 may correspond to a narrative of that row of data with an LLM instruction to convert that narrative and data to an embedding. LLM 206 or another LLM is then called again to generate an embedding 208 using prompts 204. This may correspond to a numerical or mathematical representation, such as a vector of n-dimensionality, that represents the categorical and/or numerical data in a format that may be more easily clustered and processed when training an ML model using a clustering algorithm, such as k-means clustering. Embeddings 208 are then clustered by applying a clustering algorithm 210 to embeddings 208, which creates clusters 212 having centers or centroids, cluster membership of member data points (e.g., data rows or records from the unlabeled tabular data or other data table corresponding to raw data 202), and cluster size or distance for affiliation and inference when other data records, points, or the like is processed and similarities calculated (e.g., when processing transactions to identify potential fraud through cluster relationships and/or similarities including calculating similarity scores or distances between clusters, centroids, and/or additional vectors, embeddings, or the like of new or incoming data). Clusters 212 resulting from applying clustering algorithm 210 to embeddings 208 may therefore be used to create an ML clustering model that enables systems to automate similarity processing and inferencing during automated predictions, decision-making, and the like, such as for fraud detection.

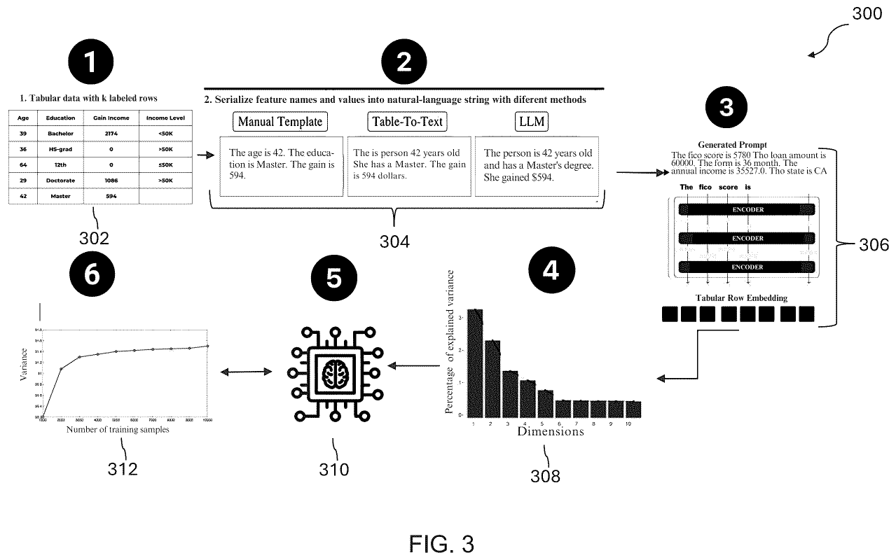

FIG. 3 is a simplified diagram for prompting an LLM with instructions to create embeddings from categorical data for ML clustering according to some embodiments. Diagram 300 of FIG. 3 represents the data pipeline and/or series of interactions from diagram 200 of FIG. 2 in further detail. For example, a data table 302 may be processed for training an ML model, such as ML model 124 trained by model training platform 130 and implemented by fraud reporting system 120 discussed in reference to environment 100 of FIG. 1. In this regard, diagram 300 displays the data processing pipeline for model training based on embeddings created from categorical data.

At a step 1, data table 302 is received and/or accessed for model training, which includes categorical data requiring processing for representation as an embedding, vector, or the like of the corresponding categorical observations for different data variables or ML features. For example, data table 302 may include tabular data having k labeled rows for different data records, however, other unlabeled tabular data may also be used. The rows each have corresponding values (e.g., as numerical or categorical data) for the columns for different variables of the data set. With the feature engineering, the ML features used for the predictive model may be selected and/or engineered from model inferencing goals or requirements. Features may be categorical or numerical and may include a mix of such data in the columns as shown in data table 302. As such, with an ML cluster modeling, it may be desirable to create peer groups based on ML clustered data from data table 302 and, based on the peer groups, identify another party's behavior. If behavior of the party is different from their peer group, an issue may be raised. Similarly, if the behavior of a party is similar to a peer group with particular historical behavior (e.g., similar to fraudulent actors or behaviors), the ML system may raise an issue. These alerts and alert generation may be threshold based, which may be pre-set by a user or determined by the ML based on prior data or other input. As such, at step 1, data table 302 may be preprocessed and/or filtered in order to generate a data set of rows corresponding to the engineered ML features, which may then be used for narrative generation at a step 2.

At a step 2, once the data is finalized and preprocessed, narrative generation may be performed to create narratives from the numerical and/or categorical data. An LLM may be trained to generate embeddings of a high degree of dimensionality to provide an understanding and/or relationship between the categorical data and its representation in embedding form, which may provide better ML model training and accuracy. Since LLMs may understand the meaning of categorical values, LLMs may perform better at representing categorical data than traditional encoding techniques that merely encode data to a random state (e.g., one-hot encoding). However, an LLM may require or only accept a prompt or text as input, and therefore tabular data input, such as data table 302, may not be accepted and may be required to be converted to narrative form and format. As such, a format to convert each row of data into a form of narratives 304 may be determined. This may include taking each row of data and converting into JSON format, thereafter, converting the JSON format in a JSON container for the narratives.

Step 2 may be done by different processing include a manual template, a table-to-text form, or an LLM generation. With a manual template, a template of the narrative is used to insert data from the columns or variables of the row to a manually generated and configured template. A table-to-text form may be generated using a natural language processor or other AI engine that describes the data from each column in the data row in the form of a sentence, paragraph, phrase, or other description. With LLM generation, the process may include providing the raw data from a row in JSON format with an instruction to an LLM to generate a narrative of the raw data from the row. The LLM may be prompted using a prompt created from a prompt template. As such, the prompt may include an instruction to generate narratives 304 from the data in the row, as well as an instruction to reduce hallucinations by only using the raw data from the row.

At a step 3, embeddings from narratives 304 are generated through an encoding process 306 by an LLM, such as OpenAI. In this regard, an API of the LLM may be called for each narrative and the LLM may be prompted, such as through an LLM prompt that includes the narrative and an instruction to convert the narrative to an embedding using encoding process 306. As such, the LLM may convert the narrative to an embedding for that particular row, and each row of the data table may be processed in serial or parallel in this manner to generate the embeddings of data table 302. The output of the LLM from encoding process 306 may correspond to a set of vectors representing the rows of data table 302, which may then be stored to a vector database. As such, these embeddings may represent the text data converted to numerical format in a representation that is acceptable for ML clustering model input and clustering. Executable code for an API call may be used with a function to obtain an embedding from the narrative text as input, which may use a pre-trained language model such as “text-embedding-ada-002” from OpenAI. The API may return a response object that contains the embedded representation of the input text as a list or vector of dimensions corresponding to the features or other data. The embedding size may be of a particular dimensionality based on the input text, features, and the like.

Prompts from steps 2 and/or 3 may be created that are to be passed to the generative AI service (e.g., LLM or the like) by embedding the examples, instructions, and the like with the input JSON components. This may be done as a string concatenation operation and may create and generate updated prompts having the data row or narrative in input JSON form. In this regard, prompting may correspond to a technique of providing instructions as part of the input to the generative AI model on how the model should generate its output. The input prompt may contain instructions on how to generate embeddings corresponding to some data, data string, or the like in the data container, which may be passed as part of the prompt. As such, the prompts may cause a generative AI, such as an LLM, GPT, or the like, to respond with conversational dialog or other information for narratives or embeddings.

A first type of prompting strategy and corresponding prompt templates may correspond to a “single zero-shot prompting call” technique where the instructions to generate a narrative are embedded in one prompt, which involves only one interaction with the LLM or other generative AI. A second type of strategy and templates may correspond to a “generation-by-parts” technique that generates the narrative by parts/sections. For faster processing, the technique can be parallelized so that sections are generated in parallel. Lastly, with a third type of prompting strategy and templates, a “few-shot prompting” technique may be used where the prompt contains examples of input-output pairs. Additional or alternative strategies available in the art may be used based on the guidance herein. The examples can be of any number allowable for the generative AI's or LLM's context window (e.g., max length of the input and output combined). This last technique may also be used with the aforementioned first and second techniques. When generating narratives and/or embeddings, hallucinations by the generative AI may be an issue, where hallucinations may correspond to a phenomenon where the models make up information even when (or particularly when) the information is not available to the models in the process of generating a response or other text. To handle hallucinations, the prompts may include explicit instructions to use only the information available in the input and to refrain from providing any information that is not available in the input to create the narrative.

As such, at a step 4, dimensionality of the embeddings is reduced by transforming the embeddings in a vector space of higher dimensionality to a vector space of lower dimensionality. With may be done using PCA or other dimensionality reduction techniques, which seek to reduce the dimensionality of the embeddings so that models do not overfit the data. As shown in diagram 300, dimensions 308 may have a different effect on the percentage of explained variances, and, as such, a number of dimensions or features may reach an optimal number for better model performance when reduced. PCA may correspond to a technique of feature extraction that maps a higher dimensional feature space to a lower dimensional feature space. While reducing the number of dimensions, PCA may seek to ensure that maximum information of the original dataset is retained in the dataset with the reduced number of dimensions and the co-relationship between the newly obtained dimensions or features is at a minimum (e.g., there are no or limited overlapping features).

At a step 5, a model training 310 is performed. In some embodiments, cluster model training may be performed using k-means clustering, however, other clustering algorithms available in the art may be selected for additional or alternative use. K-means clustering may correspond to an unsupervised ML algorithm that may be used to partition the embeddings from data table 302 into clusters. This may seek to group similar data points or embeddings while keeping dissimilar data points apart. During model training 310, initialization, assignment, and centroid update may be performed iteratively until convergence criteria are met, such as when the centroids no longer significantly change (e.g., location) or a maximum number of iterations are reached. The algorithm may therefore seek to converge on a final set of cluster centroids where each embedding is assigned to a cluster. In this regard, initialization may correspond to choosing the number of cluster (k) and randomly initializing k cluster centroids. During assignment each data point is assigned to the nearest cluster/centroid and/or grouped into clusters using a distance metric (e.g., Euclidean distance) based on the centroids. Updating of the centroids may thereafter correspond to computing the mean of all data points assigned to each cluster and updating or changing the centroid to that mean. These steps are then iteratively repeated until the stopping condition is met.

At a step 6, model performance 312 is then evaluated. After model development, it may become important to evaluate the model on some parameters to ensure that the model is behaving correctly and/or adequately for the task at hand, such as fraud detection or other inferencing based on similar or dissimilar behavior of grouped peers. For example, the data points may be visualized in a chart and the clusters may be shown so that cluster size, membership, overlap, distance from other clusters, and the like may be evaluated. The results may also be compared to other embedding and clustering, or simply clustering from traditionally encoded states of categorical data, to evaluate model performance, as well as LLM performance for embedding generation.

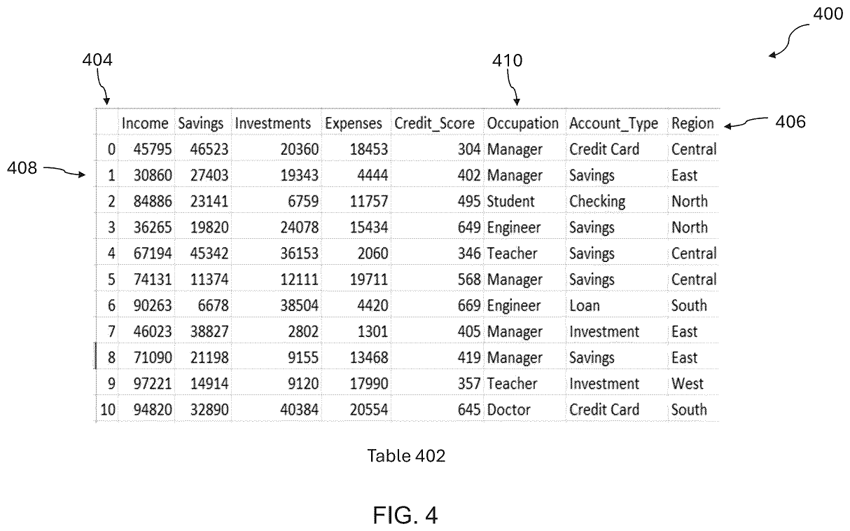

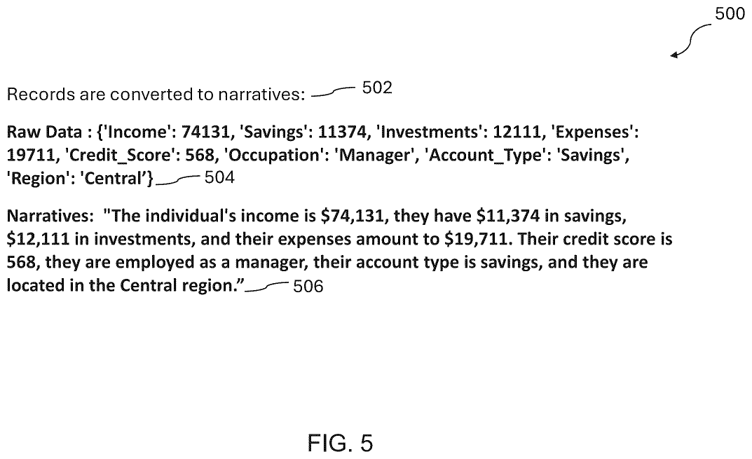

FIG. 4 is a simplified diagram 400 of an exemplary table of categorical data having rows for different records including variables for categorical observations according to some embodiments. FIG. 4 includes a table 402 that may be converted to a narrative 502 shown in FIG. 5. In this regard, FIG. 5 is a simplified diagram 500 of an exemplary prompt to an LLM when instructing the LLM to generate embeddings from categorical data according to some embodiments. As such, diagrams 400 and 500 include representations of the original raw data including categorical observations that is converted to a corresponding narrative that may be used for LLM prompting and embedding generation.

For example, with table 402, rows 404 each represent a corresponding data record while columns 406 represent different data variables for numerical or categorical data. Columns 406 may include direct values for certain numerical variables, such as “Income,” while categorical data may have a description, text, or other categorical observation in a non-quantifiable form. This may require a conversion of the data to an embedding by an LLM for more accurate ML clustering and model training. As such, a row 408 may be selected to be converted to a narrative for LLM prompting and embedding generation. However, different columns, such as a column 410 for “Occupation,” may include text that requires encoding to a state that may represent the text or other data while being usable for more accurate ML model training.

In this regard, narrative 502 shows an example of raw data 504 taken directly from row 408 and formatted as a data string for insertion in a JSON container or other data container or structure for LLM calling and prompting. Raw data 504 may therefore correspond to a portion of a prompt to an LLM for narrative generation. However, other narrative generation processes may be used in place of or in addition to LLM generation (e.g., manual templates, table-to-text, etc.). An LLM or other narrative generation process may receive the data string for raw data 504 in a container and may process the data based on instructions, templates, natural language processing, and the like, or any combination thereof, to create a narrative text 506 that describes the values or observations in raw data 504. As shown in diagram 500, the text now represents raw data 504 in a conversational or text-based manner that may be capable of being processed using an LLM. Thus, narrative text 506 may then be used in another LLM prompt that seeks to generate an embedding by converting and encoding the narrative to a vector or other mathematical or algorithmic representation of the numerical and/or categorical data.

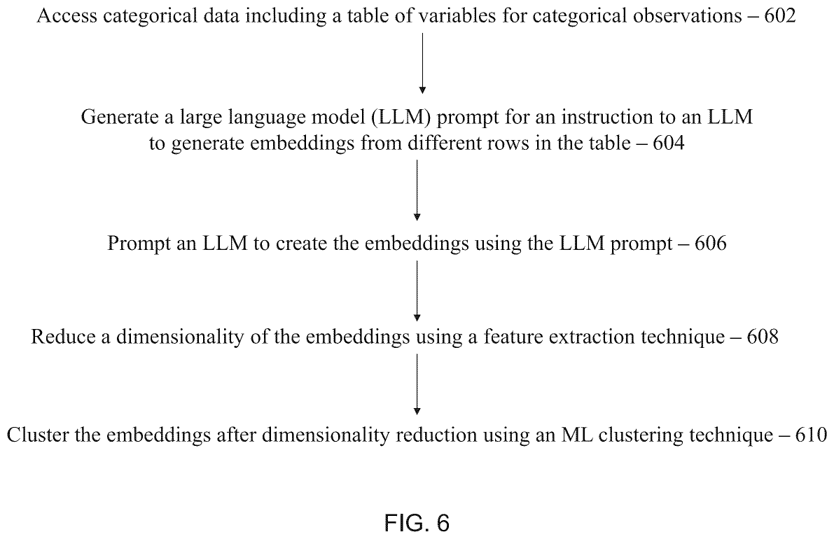

FIG. 6 is a simplified diagram of an exemplary flowchart 600 for generating embeddings of categorical data for ML clustering according to some embodiments. Note that one or more steps, processes, and methods described herein of flowchart 600 may be omitted, performed in a different sequence, or combined as desired or appropriate based on the guidance provided herein. Flowchart 600 of FIG. 6 includes operations executable by an ML modeling system that generates embeddings from categorical data for clustering using ML clustering algorithms and techniques, as discussed in reference to FIG. 1-5. One or more of steps 602-610 of flowchart 600 may be implemented, at least in part, in the form of executable code stored on non-transitory, tangible, machine-readable media that when run by one or more processors may cause the one or more processors to perform one or more of steps 602-610. In some embodiments, flowchart 600 can be performed by one or more computing devices discussed in environment 100 of FIG. 1.

At step 602 of flowchart 600, categorical data including a table of variables for categorical observations is accessed. In this regard, categorical data may correspond to unlabeled tabular data, such as one or more data tables that include data rows corresponding to individual data records having numerical data values for different variables, as well as categorical observations for other variables. In this regard, numerical or other quantifiable variables may be clustered by ML clustering algorithms and techniques using their direct values and/or may be easily converted to vector form by inserting or encoding their values to a vector. However, categorical observations require conversion to a vector or other representation that may be clustered based on a clustering metric, relationship, and/or algorithm, such as k-means clustering using cluster and data point distances and similarities in a vector space (e.g., a linear or other space of a dimensionality where objects or points may be placed and compared, such as n-dimensional vector space for n features, although a lower vector space than n may be used after dimensionality reduction). In traditional encoding, such as one-hot encoding, encodings may encounter data loss and/or may not adequately represent the categorical data. As such, the categorical data may instead be clustered based on embeddings created using an LLM by prompting the LLM for embedding creation from the categorical observations. Prior to embedding generation, pre-processing and/or data cleaning steps may be performed on the categorical data. This may be done before processing and/or calling a generative AI service for embedding generation so that data rows and/or categorical observations for different data records are consistent and/or do not having missing values, errors, typos, and the like.

At step 604, an LLM prompt for an instruction to an LLM to generate embeddings from different rows in the table is generated. The prompt may be generated using a narrative and/or a prompt template for conversational dialog, such as a request, statement, question, query, or the like that is designed to elicit a response from a generative AI. This may be done through querying or conversing with the LLM in a conversational manner using a chatbot or other automated conversational AI application or process, as well as through direct API calling. The prompt templates may each correspond to a particular prompting strategy, which may be used to execute the calls in a specific order and/or manner to elicit the best, most preferred, or designed response. For example, each prompt strategy for embedding generation may correspond to a separate manner used to call the generative AI service including a single zero-shot prompting call having instructions for embedding generation in a single interaction call, a generation-by-parts having instructions for embedding generation in multiple parallel calls made to the generative AI service for each data record or subset of the data records for embedding generation, multiple few-shot prompting calls having instructions for embedding generation in a set of calls made to the generative AI service with one or more examples of input-output pairs for other categorical data and/or embeddings, or other available and compatible prompting strategy.

Prompts may be created by a prompt and embedding generator extracting rows of data from the fields of the unlabeled tabular data or other data tables and entering the extracted data to one or more input fields or the like in the prompt templates. This may be done in a data container, such as a JSON object container, which may be used for transmission to the LLM and prompting the LLM. For example, an updated prompt may include categorical observation data for a name of the identified or suspected fraudster or victim of fraud, date of incident, cause of fraud/money laundering, activity, other affected parties, etc., which may be extracted from a data table and entered to a narrative and/or used to generate a narrative by prompting an LLM using a data string in JSON format or the like. This may generate a narrative of the data that summarizes the data in text form. Once a narrative is obtained of the categorical data, the prompt may be generated to include the narrative and instructions for a generative AI to process the narrative of the categorical data and provide a response including an embedding (e.g., a mathematical representation) of the categorical data. The prompt may be generated in a JSON format for transmission as a data container to the LLM in one or more API calls or the like, and the instructions may prompt the generative AI to return a JSON format data structure having the embeddings for different data rows for clustering. When generating the prompt, multiple prompt templates may be used so that multiple prompts are created that may be run in parallel using a multithreading-based processing job and different prompt templates and strategies for embedding generation and clustering (e.g., where multiple ML clustering models for testing and comparison may be generated based on differently constructed narratives and/or embeddings of categorical data).

At step 606, an LLM is prompted to create the embeddings using the LLM prompt. Calling and prompting may include executing and/or transmitting one or more API calls, requests, or the like that include the prompt, data container, or the like to the LLM, such as by providing the data container having the narrative of the categorical data with an instruction to generate an embedding to the LLM via an API call. As such, the instructions may cause the generative AI to respond by processing the narrative of the categorical data intelligently and providing embeddings that represent or condense the categorical data into a vector, value, multi-dimensional alphanumeric identifier, or the like. The instructions may include one or more sub-instructions configured to cause the generative AI to handle hallucinations by the generative AI service and remove or prevent usage of such hallucinations, where hallucinations may correspond to other data not included in the narrative. The generative AI may be called in a specified order designated by the prompt template selected, which may include individual calls done in parallel to improve speed and efficiency in prompting the generative AI.

At step 608, a dimensionality of the embeddings is reduced using a feature extraction technique. The dimensionality of the resulting embedding may be of n-dimensions in a vector space or other higher dimensionality space. The dimensionality space may correspond to the number of features for the ML model and/or in the rows of the table, which may correspond to the data in the narrative to collectively describe or narrate the data of these features. However, other numbers of dimensions may be represented by the embedding based on the corresponding narrative, LLM generation of the embedding, and/or instruction to the LLM in the prompt. The number of dimensions may be too high and result in overfitting when training the ML model (i.e., the model too closely follows the input data and does not do well at handling additional data for predictions and/or inferences). As such, a reduction of dimensionality of the embedding may be performed, such as using PCA or another feature extraction technique that maps the embedding in the higher dimensionality space to a lower dimensionality space. The dimensionality reduction process may be selected to ensure that the maximum information of the original dataset is retained when the dimensions are reduced.

At step 610, the embeddings after dimensionality reduction are clustered using an ML clustering technique. Thus, after obtaining reduced dimensionality embeddings, the embeddings may be used to train an ML clustering model by clustering the embeddings and using the resulting clusters to draw inferences to new or incoming data that closely resembles a cluster and/or data points in the cluster. For example, ML clustering models may be trained using a k-means clustering model training technique, although other clustering algorithms and techniques may also be used. K-means clustering may correspond to an unsupervised ML algorithm for partitioning data into clusters. Training may include an initialization step, an assignment step, a centroid update step, and the like, which may be performed iteratively until the centroids of clusters remain stable and do not significantly change. The resulting clusters may be used to assign new data points to clusters and allow for determination of inferences, such as if a transaction or user appears fraudulent.

As discussed above and further emphasized here, FIGS. 1-6 are merely examples of fraud reporting system 120 and corresponding methods for embedding generation of categorical data for ML clustering, which said examples should not be used to unduly limit the scope of the claims. One of ordinary skill in the art would recognize many variations, alternatives, and modifications available at any time in the art, which may be used with or in place of the foregoing description based on the guidance provided by this application.

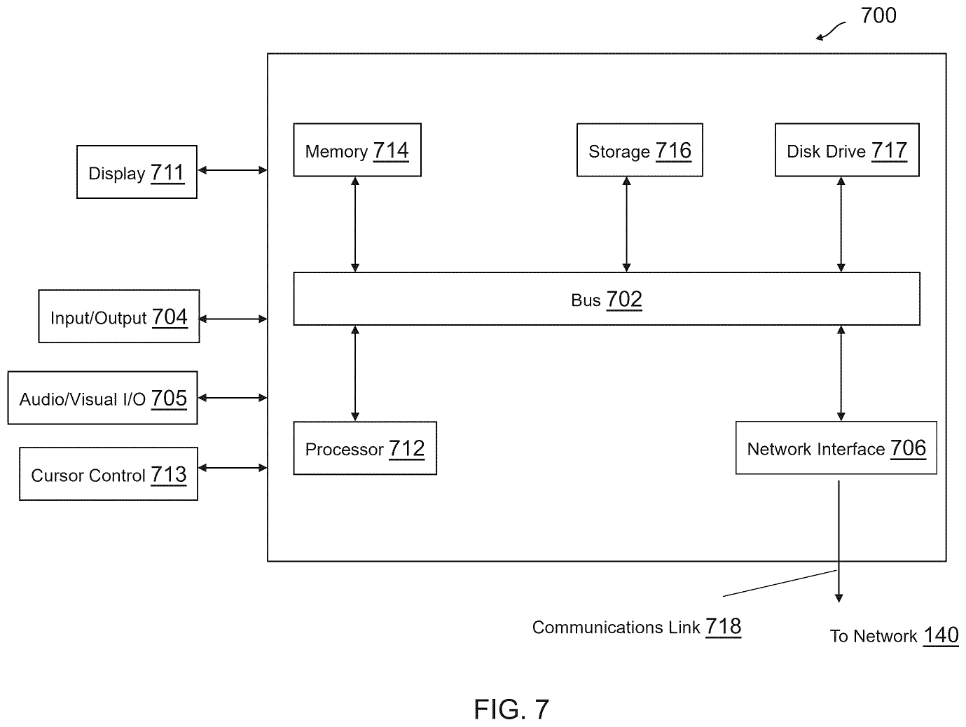

FIG. 7 is a block diagram of a computer system 700 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 700 in a manner as follows.

Computer system 700 includes a bus 702 or other communication mechanism for communicating information data, signals, and information between various components of computer system 700. Components include an input/output (I/O) component 704 that processes a user action, such as selecting keys from a keypad/keyboard, selecting one or more buttons, image, or links, and/or moving one or more images, etc., and sends a corresponding signal to bus 702. I/O component 704 may also include an output component, such as a display 711 and a cursor control 713 (such as a keyboard, keypad, mouse, etc.). An optional audio/visual input/output component 705 may also be included to allow a user to use voice for inputting information by converting audio signals. Audio/visual I/O component 705 may allow the user to hear audio, and well as input and/or output video. A transceiver or network interface 706 transmits and receives signals between computer system 700 and other devices, such as another communication device, service device, or a service provider server via network 140. In one embodiment, the transmission is wireless, although other transmission mediums and methods may also be suitable. One or more processors 712, which can be a micro-controller, digital signal processor (DSP), or other processing component, processes these various signals, such as for display on computer system 700 or transmission to other devices via a communication link 718. Processor(s) 712 may also control transmission of information, such as cookies or IP addresses, to other devices.

Components of computer system 700 also include a system memory component 714 (e.g., RAM), a static storage component 716 (e.g., ROM), and/or a disk drive 717. Computer system 700 performs specific operations by processor(s) 712 and other components by executing one or more sequences of instructions contained in system memory component 714. Logic may be encoded in a computer readable medium, which may refer to any medium that participates in providing instructions to processor(s) 712 for execution. Such a medium may take many forms, including but not limited to, non-volatile media, volatile media, and transmission media. In various embodiments, non-volatile media includes optical or magnetic disks, volatile media includes dynamic memory, such as system memory component 714, and transmission media includes coaxial cables, copper wire, and fiber optics, including wires that comprise bus 702. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 718 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A machine learning (ML) system configured to intelligently cluster categorical data based on embeddings created by prompting a large language model (LLM), the ML system comprising:
a processor and a non-transitory computer readable medium operably coupled thereto, the computer readable medium comprising a plurality of instructions stored in association therewith that are accessible to, and executable by, the processor, to perform embedding generation operations which comprise:
accessing a data set corresponding to the categorical data to be clustered by an ML clustering technique, wherein the categorical data corresponds to unlabeled tabular data for a plurality of categorical variables each corresponding to a categorical observation;
determining a first row in the unlabeled tabular data of the data set that includes first data for the plurality of categorical variables;
generating a data container corresponding to the first row and an instruction to the LLM that requests a first embedding for the first row;
prompting the LLM to create the first embedding using the data container;
reducing a dimensionality of the first embedding to a first reduced dimensionality embedding based on a feature extraction technique that maps a higher dimensionality space of the first embedding to a lower dimensionality space of the first reduced dimensionality embedding; and
outputting the first reduced dimensionality embedding to an ML training application executing the ML clustering technique for training an ML clustering model.

2. The ML system of claim 1, wherein the prompting the LLM comprises:
generating an LLM prompt that requests the first embedding be generated from the data container, wherein the dimensionality is reduced after generating the first embedding; and
transmitting the LLM prompt to the LLM via one or more application programming interface (API) calls to the LLM.

3. The ML system of claim 2, wherein the LLM prompt is generated using a prompt template from a plurality of prompt templates each created for corresponding data sets, and wherein the generating the LLM prompt includes automatically selecting or receiving a manual selection of the prompt template based on the data set.

4. The ML system of claim 2, wherein generating the LLM prompt further comprises:
converting the first row to a narrative for the LLM prompt having one or more text descriptions of the first data in the first row, wherein the LLM prompt comprises the narrative with the instruction to generate the first embedding based on the first data in the narrative.

5. The ML system of claim 1, wherein, before generating the data container, the embedding generation operations further comprise:
preprocessing the first data from the first row for a JavaScript Object Notation (JSON) data format associated with the data container.

6. The ML system of claim 1, wherein reducing the dimensionality is performed by the LLM using a principle component analysis that transforms the dimensionality of the first embedding corresponding to the plurality of categorical variables in the higher dimensionality space to the lower dimensionality space.

7. The ML system of claim 1, wherein the embedding generation operations further comprise:
generating, using the ML training application executing the ML clustering technique, a plurality of clusters for the data set using the first reduced dimensionality embedding and at least a second reduced dimensionality embedding corresponding to a second embedding generated by the LLM for at least a second row having second data in the unlabeled tabular data of the data set; and
training, using the ML training application, the ML clustering model based on the plurality of clusters.

8. The ML system of claim 7, wherein, after training the ML clustering model, the embedding generation operations further comprise
evaluating a model performance of the ML clustering model trained based on the plurality of clusters generated from the first reduced dimensionality embedding and the at least the second reduced dimensionality against the ML clustering model trained based on the plurality of clusters generated from the data set with a categorical encoding technique; and
providing an evaluation output of the model performance based on the evaluating.

9. A method to intelligently cluster categorical data based on embeddings created by prompting a large language model (LLM) for a machine learning (ML) system, the method comprising:
accessing a data set corresponding to the categorical data to be clustered by an ML clustering technique, wherein the categorical data corresponds to unlabeled tabular data for a plurality of categorical variables each corresponding to a categorical observation;
determining a first row in the unlabeled tabular data of the data set that includes first data for the plurality of categorical variables;
generating a data container corresponding to the first row and an instruction to the LLM that requests a first embedding for the first row;
prompting the LLM to create the first embedding using the data container;
reducing a dimensionality of the first embedding to a first reduced dimensionality embedding based on a feature extraction technique that maps a higher dimensionality space of the first embedding to a lower dimensionality space of the first reduced dimensionality embedding; and
outputting the first reduced dimensionality embedding to an ML training application executing the ML clustering technique for training an ML clustering model.

10. The method of claim 9, wherein the prompting the LLM comprises:
generating an LLM prompt that requests the first embedding be generated from the data container, wherein the dimensionality is reduced after generating the first embedding; and
transmitting the LLM prompt to the LLM via one or more application programming interface (API) calls to the LLM.

11. The method of claim 10, wherein the LLM prompt is generated using a prompt template from a plurality of prompt templates each created for corresponding data sets, and wherein the generating the LLM prompt includes automatically selecting or receiving a manual selection of the prompt template based on the data set.

12. The method of claim 10, wherein generating the LLM prompt further comprises:
converting the first row to a narrative for the LLM prompt having one or more text descriptions of the first data in the first row, wherein the LLM prompt comprises the narrative with the instruction to generate the first embedding based on the first data in the narrative.

13. The method of claim 9, wherein, before generating the data container, the method further comprises:
preprocessing the first data from the first row for a JavaScript Object Notation (JSON) data format associated with the data container.

14. The method of claim 9, wherein reducing the dimensionality is performed by the LLM using a principle component analysis that transforms the dimensionality of the first embedding corresponding to the plurality of categorical variables in the higher dimensionality space to the lower dimensionality space.

15. The method of claim 9, further comprising:
generating, using the ML training application executing the ML clustering technique, a plurality of clusters for the data set using the first reduced dimensionality embedding and at least a second reduced dimensionality embedding corresponding to a second embedding generated by the LLM for at least a second row having second data in the unlabeled tabular data of the data set; and
training, using the ML training application, the ML clustering model based on the plurality of clusters.

16. The method of claim 15, wherein, after training the ML clustering model, the method further comprises:
evaluating a model performance of the ML clustering model trained based on the plurality of clusters generated from the first reduced dimensionality embedding and the at least the second reduced dimensionality against the ML clustering model trained based on the plurality of clusters generated from the data set with a categorical encoding technique; and
providing an evaluation output of the model performance based on the evaluating.

17. A non-transitory computer-readable medium having stored thereon computer-readable instructions executable to automate suspicious activity report (SAR) narrative generations using prompts to a generative artificial intelligence (AI) service for a machine learning (ML) system, the computer-readable instructions executable to perform narrative generation operations which comprise:
accessing a data set corresponding to the categorical data to be clustered by an ML clustering technique, wherein the categorical data corresponds to unlabeled tabular data for a plurality of categorical variables each corresponding to a categorical observation;
determining a first row in the unlabeled tabular data of the data set that includes first data for the plurality of categorical variables;
generating a data container corresponding to the first row and an instruction to the LLM that requests a first embedding for the first row;
prompting the LLM to create the first embedding using the data container;
reducing a dimensionality of the first embedding to a first reduced dimensionality embedding based on a feature extraction technique that maps a higher dimensionality space of the first embedding to a lower dimensionality space of the first reduced dimensionality embedding; and
outputting the first reduced dimensionality embedding to an ML training application executing the ML clustering technique for training an ML clustering model.

18. The non-transitory computer-readable medium of claim 17, wherein the prompting the LLM comprises:
generating an LLM prompt that requests the first embedding be generated from the data container, wherein the dimensionality is reduced after generating the first embedding; and
transmitting the LLM prompt to the LLM via one or more application programming interface (API) calls to the LLM.

19. The non-transitory computer-readable medium of claim 18, wherein the LLM prompt is generated using a prompt template from a plurality of prompt templates each created for corresponding data sets, and wherein the generating the LLM prompt includes automatically selecting or receiving a manual selection of the prompt template based on the data set.

20. The non-transitory computer-readable medium of claim 18, wherein generating the LLM prompt further comprises:
converting the first row to a narrative for the LLM prompt having one or more text descriptions of the first data in the first row, wherein the LLM prompt comprises the narrative with the instruction to generate the first embedding based on the first data in the narrative.
